(19) United States
(12) Patent Application Publication
(10) Pub. No.: US 2008/0231859 A1
(43) Pub. Date: Sep. 25, 2008

(54) PHOTODETECTION DEVICE AND PHOTODETECTION METHOD

(75) Inventor: Masaya Ogino, Kawasaki-shi (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, Tokyo (JP)

(21) Appl. No.: 12/050,218

(22) Filed: Mar. 18, 2008

(30) Foreign Application Priority Data
Mar. 23, 2007 (JP) 2007-077275

(51) Int. Cl. G01J 3/45

(52) U.S. Cl. 356/451

(57) ABSTRACT

A photodetection device, a photodetection method, an image sensor and an image pickup method can increase the number of pixels, while suppressing degradation of the S/N ratio. The photodetection device includes a spectroscopic element formed by means of an optical microresonator having a plurality of resonant wavelength bands differentiated by positions as a function of a geometric structure and a plurality of photoelectric conversion elements arranged at different positions to detect light of the plurality of resonant wavelength bands.

### BACKGROUND OF THE INVENTION

1. Field of the Invention

This invention relates to a photodetection device to be used for light receiving and image pickup operations.

2. Description of the Related Art

Image sensors such as CCD (charge coupled devices) and CMOS (complementary metal oxide semiconductors) are being used as two-dimensional image sensors.

The trend of densely arranging an increasingly large number of pixels in an image sensor has been progressing in recent years and each unit pixel and the light receiving aperture of the pixel of such image sensors have been miniaturized to about 2 μm and 1 μm respectively.

Degradation of the S/N (signal/noise ratio) of photodiodes due to miniaturization of pixels has become a problem. The technique of utilizing the Bayer arrangement that is currently in the main stream of color separation of image sensors is disadvantageous from a viewpoint of S/N because of a poor efficiency of utilizing light.

U.S. Pat. No. 6,632,701 proposes the use of a multilayer structure formed by laying layers for receiving the three primary colors of RGB one on the other for the purpose of improving the efficiency of utilization of light.

According to the invention disclosed in the U.S. Pat. No. 6,632,701, color separation is realized by utilizing the difference of absorption coefficient of Si that arises due to wavelengths of light. However, the accuracy of color separation of the proposed technique is insufficient to make the degree of color reproduction unsatisfactory. In other words, the S/N of colors is insufficient.

Additionally, the proposed technique involves complicated wiring, entailing difficulty in miniaturization of pixels, a trade-off relationship of sensitivity and color separation and other problems that need to be alleviated.

The trend of densely arranging an increasingly large number of pixels in a two-dimensional image sensor is remarkable. Due to the large number of pixels in an image sensor, a unit pixel and the aperture of the light shielding film of the pixel that operates as light receiving area have been miniaturized to about 2 μm and 1 μm respectively.

While there are various views on increasing the number of pixels of an image sensor, a recognized major disadvantage of such an increased number of pixels is degradation of sensitivity due to miniaturization of pixels. On the other hand, the use of a large number of densely arranged pixels provides advantages.

Thus, suppression of degradation of the S/N of light is an important task to be tackled for the technological development of image sensors in the future.

Additionally, with the conventional technique of defining the light receiving region of a unit pixel by means of the aperture formed in the light shielding film on a photodiode, when the size of the pixel (aperture) becomes the level of the wavelength of light, the quantity of light that passes through the aperture remarkably falls due to the diffraction limit to consequently degrade the S/N of light intensity.

With the Bayer arrangement that is being currently popularly employed as a color separation method for two-dimensional image sensors, light is subjected to color separation by arranging a filter of a color selected from R (red), G (green) and B (blue) in front of each of two-dimensionally arranged pixels that are formed by so many photodiodes.

Therefore, a pixel receives only R, G or B light. Light of the other colors is absorbed by the filter. So the use efficiency of light is low.

Thus firstly, as pointed out above, while the pixels of two-dimensional image sensors have been miniaturized to increase the number of pixels of the image sensor, both the poor use efficiency of light and the miniaturized region of the photodiode of each pixel degrade the S/N ratio of light. And secondly, there is an additional problem that the S/N ratio of light intensity is degraded extremely because of a fall of the intensity of transmitted light when the size of the aperture of the light shielding film that marks off the pixel is reduced to the level of the wavelengths of light due to the diffraction limit of light.

### SUMMARY OF THE INVENTION

According to an aspect of the present invention, there is provided a photodetection device including: a spectroscopic element formed by means of an optical microresonator having a plurality of resonant wavelength bands differentiated by positions as a function of geometric structure; and a plurality of photoelectric conversion elements arranged at different positions to detect incident intensities of light of the plurality of resonant wavelength bands.

According to another aspect of the present invention, there is provided a photodetection device including: a spectroscopic element adapted to show a plurality of different resonant wavelength bands differentiated as a function of a geometric structure of an optical microresonator; and a plurality of photoelectric conversion elements arranged at different positions to detect light of the plurality of resonant wavelength bands.

According to still another aspect of the present invention, there is provided a photodetection method including steps of: making light to enter a spectroscopic element formed by means of an optical microresonator having different resonant wavelength bands differentiated by positions as a function of geometric structure; detecting a spatial polarization of photoelectromagnetic field distribution produced by resonance caused by the spectroscopic element as an optical intensity of each wavelength band by means of photoelectric conversion elements arranged at spatially different positions; and outputting the detected optical intensity as signal.

With a photodetection device according to the present invention, the number of pixels can be increased, while suppressing degradation of the S/N of light by using a multi-mode (i.e., having a plurality of resonant wavelength bands) optical microresonator type photodetection device.

Further features of the present invention will become apparent from the following description of exemplary embodiments with reference to the attached drawings.

### BRIEF DESCRIPTION OF THE DRAWINGS

FIG. 1 is a schematic illustration of a scalene triangle illustrating the form of a microresonator according to the present invention;

FIG. 2 is a schematic illustration of an arrangement of microresonators according to the present invention;

FIG. 3 is a schematic illustration the structure of a photodetection device formed by means of a scalene triangle resonator;

FIG. 4 is a schematic illustration of the structure of a photodetection device formed by means of a microresonator having a quasi-fractal structure;

FIGS. 5A, 5B, 5C and 5D are a schematic illustration of the structures of microresonators having a plurality of resonance lengths;

FIGS. 6A, 6B and 6C schematically illustrate that the sites of anti-nodes and those of nodes of electric fields differ as a function of wavelength, in a whispering gallery mode resonator;

FIG. 7 is a graph illustrating the sites of anti-nodes and those of nodes of the electric field of wavelength as developed in a circumferential direction of a whispering gallery mode resonator; and

FIG. 8 is a schematic illustration of the structure of a photodetection device formed by means of a whispering gallery mode resonator.

### DESCRIPTION OF THE EMBODIMENTS

A photodetection device according to the present invention has: a spectroscopic element formed by means of an optical microresonator having a plurality of resonant wavelength bands differentiated by positions as a function of geometric structure; and a plurality of photoelectric conversion elements arranged at different positions to detect incident intensities of light of the plurality of resonant wavelength bands.

Alternatively, a photodetection device according to the present invention has: a spectroscopic element adapted to show a plurality of different resonant wavelength bands differentiated as a function of a geometric structure of an optical microresonator; and a plurality of photoelectric conversion elements arranged at different positions to detect light of the plurality of resonant wavelength bands.

For the purpose of the present invention, an electromagnetic response may be detected by the photodetection device.

Alternatively, a thermal response may be detected by the photodetection device.

Still alternatively, a chemical response may be detected by the photodetection device.

For the purpose of the present invention, the optical microresonator may be made of a metal.

The optical microresonator may also be made of a semiconductor.

The optical microresonator may also be made of a dielectric.

The optical microresonator may also be made of a monocrystalline material.

The optical microresonator may also be made of a polycrystalline material.

The optical microresonator may also be made of an amorphous material.

The optical microresonator may also be made of a plasmon resonator.

The optical microresonator may also be made of a whispering gallery mode resonator.

The photoelectric conversion elements may be made of a photovoltaic material.

The photoelectric conversion elements may also be made of a photoconductive material.

The photoelectric conversion elements may also be made of a material that responds to light with energy higher than the wavelength band of incident propagating light.

The present invention also provides an image sensor. An image sensor according to the present invention has a structure formed by two-dimensionally arranging optical microresonators according to the present invention on a planar surface or a curved surface.

The present invention further provides a photodetection method. A photodetection method according to the present invention includes steps of: making light to enter a spectroscopic element formed by means of an optical microresonator having different resonant wavelength bands differentiated by positions as a function of a geometric structure; detecting a spatial polarization of photoelectromagnetic field distribution produced by resonance caused by the spectroscopic element as an optical intensity of each wavelength band by means of photoelectric conversion elements arranged at spatially different positions; and outputting the detected optical intensity as signal.

In the method as defined above according to the present invention, a nonadiabatic process may be used for detecting the spatial polarization by resonance of light.

The method as defined above according to the present invention may further include steps of: reconstruction a color of incident light from the detection signal output; and outputting the color as signal.

The method as defined above according to the present invention may be adapted to detect a two-dimensional distribution of optical intensity signal output based on the two-dimensional arrangement of optical microresonators, the optical microresonators being arranged two-dimensionally on a planar surface or a curved surface.

Thus, according to the present invention, there is provided a photodetection device formed by means of an optical microresonator having a plurality of resonant wavelength bands and adapted to spatially localize the energy of light caused to resonate by a resonator. A photodetection device according to the present invention can realize spectroscopic detection of light without using a filter and separate pixels without relying on apertures of light shielding films.

As no apertures are required, pixels now can be arranged at a pitch less than the wavelength of light without degrading the S/N of light if compared with image sensors having a pixel structure equipped with apertures.

A multi-mode optical microresonator type photodetection device according to the present invention involves the following advantageous points in its application.

A two-dimensional image sensor can be made to have a large number of pixels densely arranged at a pitch less than the wavelength of light without degradation of the S/N of detection otherwise caused by the diffraction limit of apertures. Thus, a thin two-dimensional image sensor that can utilize light highly efficiently can be realized because a single pixel can receive rays of light of three different colors of R, G and B.

A multi-mode optical microresonator type photodetection device according to the present invention can be formed by arranging a multi-mode optical microresonator in the vicinity of photoelectric conversion elements using a photovoltaic material such as Si or Ge or a photoconductive material such as Se or ZnO.

For the purpose of the present invention, an optical microresonator is an optical resonator formed by using a member of a size less than the wavelength band of light (of the order of nanometers).

Examples of optical microresonators that can be used for the purpose of the present invention include plasmon resonators and whispering gallery mode resonators having a plurality of resonant wavelength bands differentiated as a function of the geometric structure thereof.

Such optical microresonators show a plurality of wavelengths as a function of the positions in the geometric structure thereof.

The resonance wavelengths can be changed by appropriately designing the geometric structure of the resonator. Such a resonator can be designed to posses a plurality of resonance wavelengths (e.g., 350 nm, 500 nm and 650 nm). Such a plurality of resonance wavelengths can be realized by any of various structures of resonators.

Since the resonance wavelengths of an optical microresonator are basically significantly influenced by the spatial frequency component that is approximately equal to the wavelengths of light of the structure of the resonator, the plurality of resonance wavelengths can be controlled by adjusting the spatial frequency component.

The materials that can be used to form a microresonator include metals, semiconductors and dielectrics. Those materials may be monocrystalline, polycrystalline or amorphous so long as the structure of the microresonator is made to interact with light.

A plasmon resonator or a whispering gallery mode resonator having a plurality of resonance wavelengths can be regarded as a complex formed by laying a plurality of electric dipoles or magnetic dipoles having different resonance frequencies one on the other.

The intensities of incident light that correspond to the respective dipoles of the complex are separated and detected by means of photodetectors formed so as to be spatially separated.

If the correspondence of various wavelength components of incident light and dipoles to which the wavelength components are assigned is known, the intensity of any desired wavelength band of light can be obtained.

Now, exemplary embodiments of the present invention will be described in greater detail by referring to the accompanying drawings.

Firstly, how sites that are spatially differentiated from each other in terms of resonance wavelength are produced on a plasmon resonator will be specifically described.

As light strikes metal micro-particles, surface plasmon resonance is excited. Excitation of surface plasmon occurs when electrons in the metal are coupled to the light along the interface of the metal micro-particles and the surrounding space.

The excited surface plasmon is scattered at discontinuous points of curvature in the direction of polarization of incident light in the metal micro-particle structure and a standing wave is produced as scattered plasmons interfere with each other to form a mode of localized surface plasmon.

The standing wave is defined by the distribution of discontinuous points of curvature along the interface of the metal micro-particles, or the three-dimensional structure of the plasmon resonator and the wavelength of surface plasmon (wave).

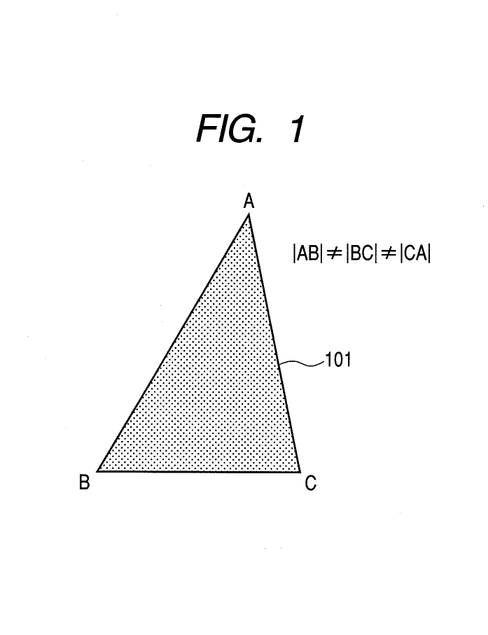

A plasmon resonator 101 having a profile of a scalene triangle plate as illustrated in FIG. 1 has a plurality of modes of the lowest order because of shape anisotropy.

These modes produce resonance at spatially different sites. By paying attention to vertexes where the electric field is apt to be concentrated, it will be seen that the extent of superposition of different modes that contribute to electric field enhancement differs among the three vertexes of A, B and C. The ratio of the intensities of the three colors of R, G and B is detected by utilizing the difference.

A plasmon resonator can resonate with light having a wavelength longer (larger) than the structure of the resonator.

This is because, when light strikes a metal microresonator having a size less than the wavelength of light, the light is scattered by the metal microresonator to give rise to diffraction components of higher orders and hence light with various wave numbers.

Generally, while propagating light and electron wave in metal cannot provide phase matching and no surface plasmon wave is excited, the phase matching condition is satisfied by the scattering effect and light and electron motion are coupled to produce surface plasmon.

The surface plasmon that is produced as a result of coupling light and electron wave has a wavelength shorter than the wavelength of light before the coupling. Therefore, even if the structure is too small for light to resonate, resonance occurs when surface plasmon is produced.

In other words, a plasmon resonator can resonate with light having a wavelength larger than its own size. So plasmon resonators can be arranged at a narrow pitch of arrangement as a photodetector.

Thus, a photodetector according to the present invention can be made to have a large number of densely arranged pixels because pixels having a size less than the wavelength of light are arranged without using apertures, utilizing the properties of plasmon resonators and whispering gallery mode resonators, and the three primary colors of R, G and B can be obtained by means of a single pixel.

When pixels are formed without using apertures, the components of propagating light that are not related to resonance can give rise to noise.

However, the part taken by propagating light is relatively small when light localized by the structure is intense so that such noise is not significant.

The nonadiabatic mutual action of near field described in Journal of Luminescence 122-123 (2007) 230-233 provides the following possibilities.

Since not only electrons but also phonons are excited due to a sharp gradient of electric field in a near field region, photoelectric conversion can be realized by incident light of even a low energy level.

Therefore, a photoelectric conversion element not sensitive to the wavelength of entered propagating light can be made sensitive to the optical near field in the vicinity of a resonator.

Then, the optical intensity of the target of detection can be separated from the entered propagating light by utilizing this property of the photoelectric conversion element without using any aperture.

Additionally, while materials that can be used for photoelectric conversion in the infrared region are limited because infrared rays show a low energy level if compared with visible rays of light, Si that is a popular material for photoelectric conversion can also be used for the purpose of the present invention by utilizing the nonadiabatic mutual action of near field.

A specific method of detecting the color of incident light will be described below in terms of a scalene triangle plasmon resonator 101.

As light strikes a scalene triangle plasmon resonator 101, the motion of electrons is restricted at the vertexes and the electric field is concentrated so that the state of plasmon resonance can be sensed with ease. Then, three photo-diodes are formed corresponding to the vicinities of the three points (A, B and C) to observe the intensity of light.

Firstly, a spectral sensitivity to be desirably obtained for R, G and B is defined in advance and expressed as fⱼ(λ) (j=r, g or b). The intensity of incidence of light of the spectral sensitivity fⱼ(λ) is expressed as Cⱼ (j=r, g or b).

The values of Cⱼ are the values to be obtained. Restrictions imposed on the definition of a spectral sensitivity fⱼ(λ) for R, G and B include that all the wavelengths of light in the visible region can be discriminated and that the intensity Cⱼ of incident light can also be known at the same time.

Considering the above requirements, it is desirable that neighboring fⱼ(λ)s overlap. It is more desirable that neighboring fⱼ(λ)s overlap by about a half value of the peak.

The electric field intensity Iᵢ (i=a, b or c) produced at the vertexes A, B and C of the triangle is the sum of the contributions of light of the wavelengths included in incident light.

Hence,

$${I}_{i} = {\int }_{vis} {R}_{i} ( λ ) {f}_{r} ( λ ) {C}_{r} d λ + {\int }_{vis} {R}_{i} ( λ ) {f}_{g} ( λ ) {C}_{g} d λ + {\int }_{vis}^{ } {R}_{i} ( λ ) {f}_{b} ( λ ) {C}_{b} d λ \\ ( i = a , b or c )$$

$$Or$$

$${I}_{i} = {\sum }_{j = r , g , b} {\int }_{vis} {R}_{i} ( λ ) {f}_{j} ( λ ) {C}_{j} d λ \\ ( i = a , b , c )$$

where Rᵢ(λ) is the ratio by which the intensity of light with wavelength λ is distributed to i=a, b or c.

Since Cⱼ is not dependent on λ, the above formula can also be expressed by the formula illustrated below.

$${I}_{i} = {\sum }_{j = r , g , b} \{ {\int }_{vis} {R}_{i} ( λ ) {f}_{j} ( λ ) d λ \} {C}_{j} \\ ( i = a , b , c )$$

It can be expressed by a matrix expression as illustrated below:

$${I}_{i} = {S}_{ij} {C}_{j}$$

$$where$$

$${S}_{ij} = ( \begin{matrix}{\int }_{vis} {R}_{a} ( λ ) {f}_{r} ( λ ) d λ & {\int }_{vis} {R}_{a} ( λ ) {f}_{g} ( λ ) d λ & {\int }_{vis} {R}_{a} ( λ ) {f}_{b} ( λ ) d λ \\ {\int }_{vis} {R}_{b} ( λ ) {f}_{r} ( λ ) d λ & {\int }_{vis} {R}_{b} ( λ ) {f}_{g} ( λ ) d λ & {\int }_{vis} {R}_{b} ( λ ) {f}_{b} ( λ ) d λ \\ {\int }_{vis} {R}_{c} ( λ ) {f}_{r} ( λ ) d λ & {\int }_{vis} {R}_{c} ( λ ) {f}_{g} ( λ ) d λ & {\int }_{vis} {R}_{c} ( λ ) {f}_{b} ( λ ) d λ\end{matrix} )$$

The values of Rᵢ(λ) (i=a, b or c) can be obtained by observing the intensity of the electric field at each of the vertexes, irradiating the plasmon resonator with light of a single wavelength and shifting the wavelength, by means of an electromagnetic field analysis or in an experiment.

The values of fⱼ(λ) (j=r, g or b) is a spectral sensitivity and can be defined within the above restrictions.

Therefore, Sᵢⱼ is a matrix that is uniquely determined by the structure of the plasmon resonator and the defined spectral sensitivity.

The intensity ratio Cⱼ of R, G and B can be obtained by the formula illustrated below.

Cⱼ=Sᵢⱼ⁻¹Iᵢ

As a human being sees rays of visible light, he or she perceives the color of light that may vary as a function of the spectrum characteristics thereof. However, all the colors can be reproduced by mixing rays of light of the three primary colors.

In other words, the color of light perceived by a human being can be known by finding the intensity ratio of the R, G and B components of light entering the eyes of the human being. Thus, a two-dimensional color image can be formed by arranging the intensity ratios (colors) obtained from the resonators that are two-dimensionally arranged.

A photodetector according to the present invention can interact with light having wavelengths larger (longer) than the size of the plasmon resonator 101 because of the characteristics of the plasmon resonator 101 or a whispering gallery mode resonator, if such a resonator is used.

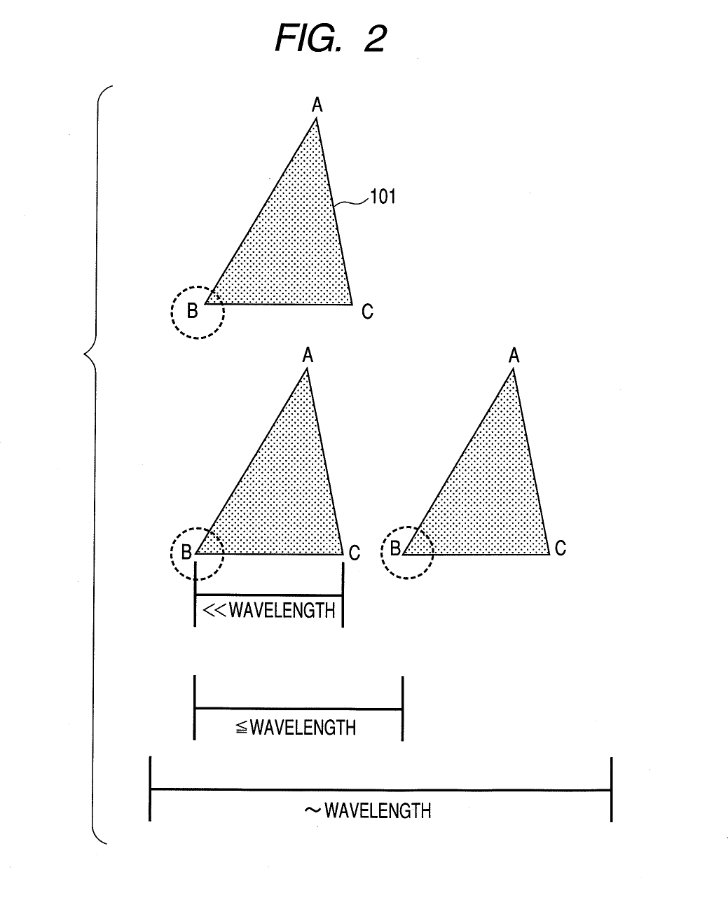

FIG. 2 is a schematic illustration of an arrangement of microresonators according to the present invention, illustrating the positional relationship thereof and the wavelengths that can be detected by using the corners B of the plasmon resonators 101 as starting points.

As seen from FIG. 2, pixels can be arranged with gaps not larger than the wavelengths of light. Thus, a large number of pixels can be densely arranged for a short sampling period that cannot be achieved by conventional image sensors.

Additionally, since a single resonator has a plurality of resonance peak wavelengths and obtain the intensities of the respective peak waves, a large number of pixels can be densely and effectively arranged if photodetectors that correspond to R, G and B are arranged to form a mosaic.

The absorption coefficient Si, which is the photoelectric conversion material, varies relative to light having wavelength bands that correspond to the primary colors of R, G and B in ordinary image sensors.

In other words, there arises a problem that the image sensor has a too wide adaptability relative to light of B when the sensor is prepared so as to be optimized relative to light of R, whereas the image sensor has a too narrow adaptability relative to light R when the sensor is prepared so as to be optimized relative to light of B. In short, it is difficult to optimize the size of the photodiode region.

In the case of plasmon resonance or whispering gallery mode resonance, the wavelength of resonating light is localized in the vicinity of a spectroscopic element and a sufficient quantity of light can be received for R, G and B if the photodiode region is reduced.

Generally, photodetectors are arranged on a two-dimensional planar surface in an image sensor, better characteristics can be obtained when they are arranged on a two-dimensional curved surface and combined with an optical system.

An image sensor having microresonator type photodetection devices according to the present invention is adapted to light receiving methods and spectrological methods and not limited by the method of transferring signals and the method of reading signals to be used therewith. CCDs and CMOSs as well as various methods can be applied thereto.

### Embodiment 1

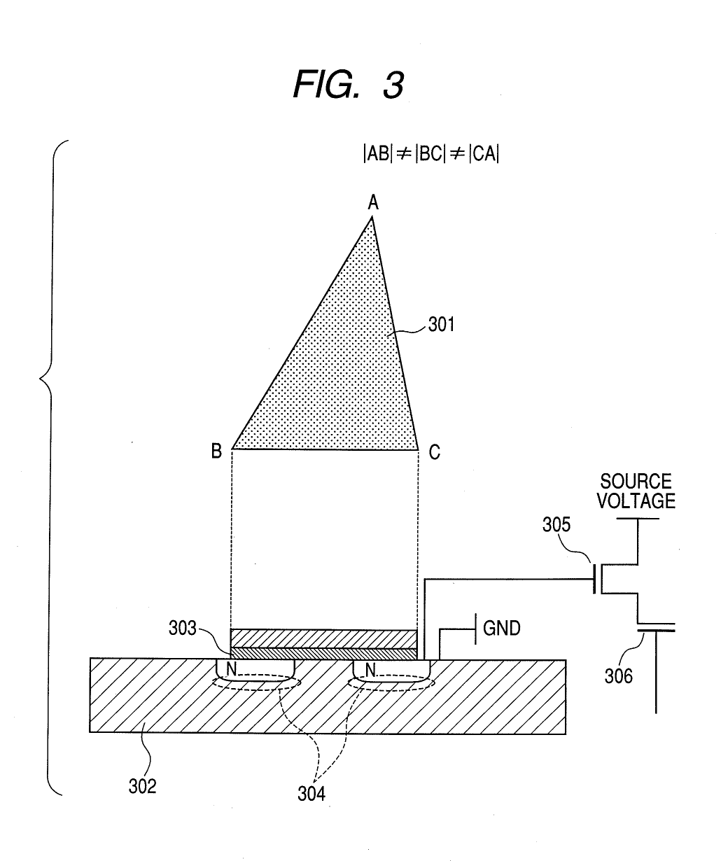

FIG. 3 is a schematic illustration of an embodiment of photodetection device according to the present invention.

A microresonator 301 is formed on an Si-made substrate 302 with a 5 nm-thick insulating film 303 typically made of SiO₂ interposed between them.

Assume that the microresonator 301 and the insulating film 303 have a triangular profile with such dimensions that the side AB=210 nm, the side BC=180 nm and the side AC=150 nm and the thickness is 50 nm and the microresonator 301 is formed by using Ag metal nano dots. The thickness of the insulating film 303 is preferably as thin as possible so long as the electric connection is broken.

The planar contour of the metal nano dots preferably illustrates a good color S/N within the spectral sensitivity relative to the target of detection. In other words, the planar contour of the metal nano dots preferably has a structure that most sensitively reacts to any spectral change of incident light within the required spectral range.

Light that strikes the photodetection device then collides with the microresonator 301 to produce localized surface plasmon resonance. As a result of the plasmon resonance, a strong electric field enhancement takes place at the three vertexes A, B and C of the metal nano dots to produce strong optical near fields.

Photodiode regions 304 are formed respectively in the vicinity of the vertexes A, B and C of the metal nano dots and independently receive light with the respective optical intensities near the vertexes A, B and C.

The photodiode regions 304 output the respective intensities of the electric fields as so many quantities of electric charges. The electric charges are accumulated and subsequently amplified by an amplifier transistor 305 and output from row selection transistor 306 with positional information.

A set of pieces of optical intensity information that corresponds to the colors of R, G and B is obtained with positional information in the two-dimensional surface. Thus, a two-dimensional image can be formed by rearranging the pieces of information.

Now, the reason why a large number of pixels can be densely arranged without being influenced by the diffraction limit when light is received with the optical intensities at the vertexes of the scalene triangle dots of the microresonator will be described.

Plasmon resonance appears as light strikes the microresonator 301. The sites that contribute to the plasmon resonance depend on the structure of the microresonator 301 and the wavelengths of light striking the microresonator 301.

A plasmon resonator can interact with light having wavelengths larger than its own structure due to a property of localized surface plasmon that is excited on a metal surface.

Light of all colors can be regarded as a mixture of the color components of the three primary colors of R, G and B. Assume here that light of a certain color strikes the microresonator 301 having a profile of a scalene triangle.

The R component of incident light produces an enhanced field with a ratio specific to light of R at each of the vertexes A, B and C of the microresonator 301. This description of producing an enhanced field at each of the vertexes A, B and C also applies to the G and B components.

Photodiode regions 304 that operate as photoelectric conversion elements are formed in the vicinity of the enhanced fields and directly receive the intensities thereof.

What is actually observed is the optical intensity at each of the vertexes A, B and C and the optical intensity at A is the sum of the optical intensity of light of R at point A, the optical intensity of light of G at point A and the optical intensity of light of B at point A. So are the optical intensities at B and C.

The optical intensity of light of each of R, G and B can be backwardly calculated by detecting the optical intensities at A, B and C by means of photodiodes if the ratio by which the R, G and B components of light are distributed to A, B and C is known in advance by means of an electromagnetic field analysis or in an experiment.

The mathematic expressions described earlier can exactly be applied to the calculations.

Thus, all the R, G and B components of light can be received in the vicinity of a resonator having a size smaller than the wavelengths of light. Therefore, a large number of pixels can be densely arranged without degrading the S/N if compared with a photodetector having an aperture, an image sensor formed by using color filters arranged in the form of a mosaic and apertures in particular.

In this example, resonance of different wavelength bands is detected by means of a photodiode as electromagnetic response.

Besides the above-described method, a method of detecting resonance by means of thermoelectric conversion of a thermal response, utilizing the Seebeck effect, or a electrochemical method of detecting a change in the electric potential of the oxidation-reduction reaction produced by light may alternatively be used.

### Embodiment 2

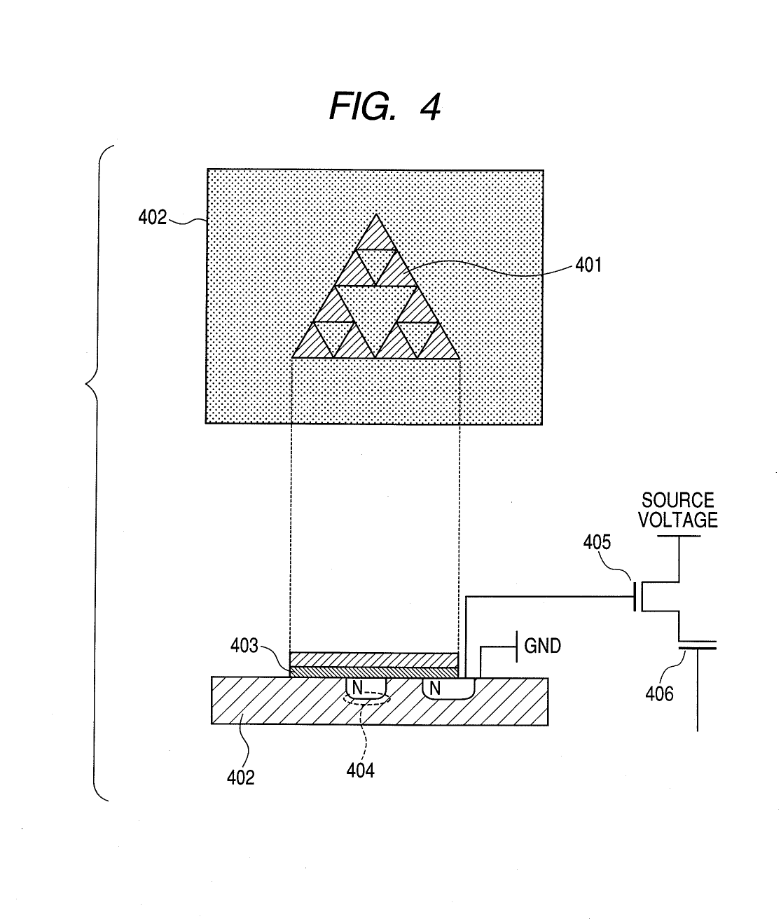

FIG. 4 is a schematic illustration of another embodiment of photodetection device according to the present invention.

A microresonator 401 is formed on an Si-made substrate 402 with a 5 nm-thick insulating film interposed between them to produce a quasi-fractal hierarchical structure of a regular triangle, where 50 nm-thick Ag dots are typically used.

The insulating film 403 is preferably as thin as possible so long as it can establish electric insulation.

The fractal structure of metal dots preferably illustrates a good color S/N within the spectral sensitivity relative to the target of detection. In other words, it preferably has a structure that most sensitively reacts to any spectral change of incident light within the required spectral range.

Light that strikes the photodetection device then collides with the microresonator 401 to produce localized surface plasmon resonance. As a result of the plasmon resonance, a strong electric field enhancement takes place at sites specific to the structure of metal nano dots to produce strong optical near fields.

Photodiode regions 404 are formed respectively in the vicinity of the sites where a strong electric field enhancement takes place and independently detect the respective intensities of resonance.

Any three positions that correspond to three sites where the wavelength dependencies of the magnitude of the plasmon resonance generated in the microresonator 401 differ from each other may be selected as sites where photodiode regions 404 are arranged.

The photodiode regions 404 output the respective intensities of the electric fields as so many quantities of electric charges. The electric charges are accumulated and subsequently amplified by an amplifier transistor 405 and output from row selection transistor 406 with positional information.

A set of pieces of optical intensity information that correspond to the colors of R, G and B is obtained with positional information in the two-dimensional surface. Thus, a two-dimensional image can be formed by rearranging the pieces of information.

The description why light of the three primary colors of R, G and B can be received given above for Embodiment 1 also applies to this embodiment. In short, the difference in the distribution of resonance in a microresonator that takes place due to the wavelengths of light is utilized.

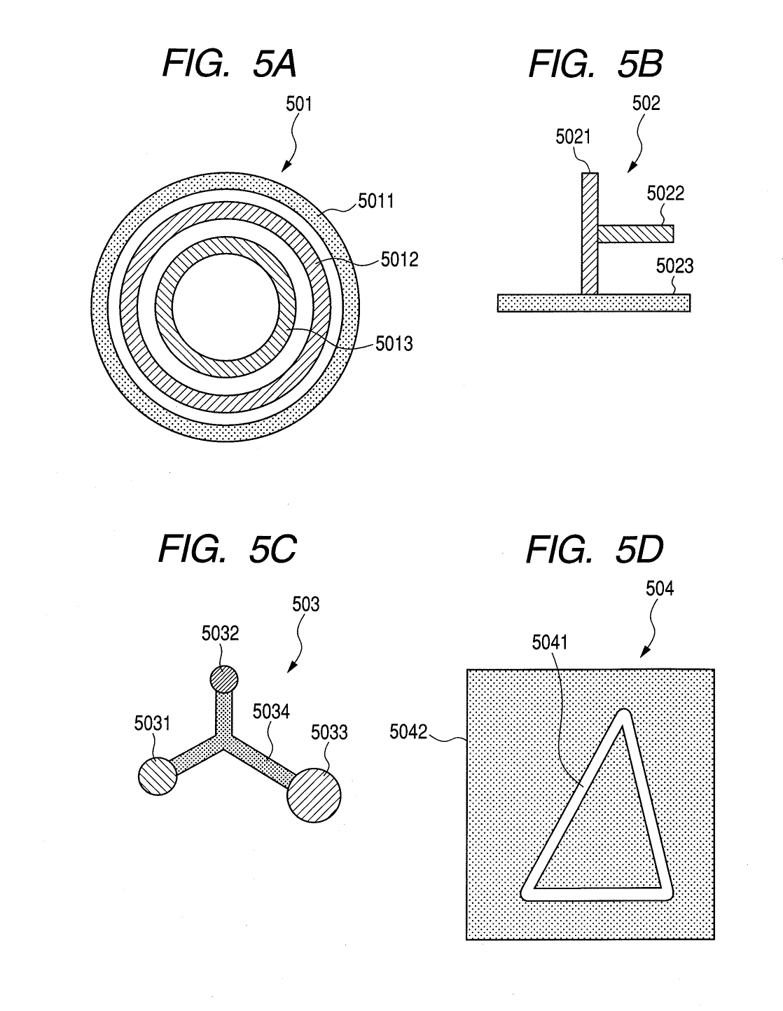

FIGS. 5A through 5D are a schematic illustration of microresonators formed by using metal nano dots or metal nano holes having a plurality of resonance lengths.

In the microresonator 501 illustrated in FIG. 5A, annular metal nano dots 5011, 5012, 5013 having different diameters are arranged coaxially.

Any three positions that correspond to three sites where the magnitudes of the plasmon resonance generated in the microresonator 501 differ from each other may be selected as sites where photodiode regions are arranged. For example, they may be selected immediately below the metal nano dots 5011, 5012, 5013 respectively.

A microresonator 502 illustrated in FIG. 5B is formed by combining and arranging rectangular metal nano dots 5021, 5022, 5023 having different lengths.

Any three positions that correspond to three sites where the magnitudes of the plasmon resonance generated in the microresonator 502 differ from each other may be selected as sites where photodiode regions are arranged. For example, they may be selected immediately below the metal nano dots 5021, 5022, 5023 or at opposite ends of the rectangles respectively.

In a microresonator 503 illustrated in FIG. 5C, circular metal nano dots 5031, 5032, 5033 having different diameters are combined by connectors 5034 having different lengths and extending from respective connection points.

Any three positions that correspond to three sites where the magnitudes of the plasmon resonance generated in the microresonator 503 differ from each other may be selected as sites where photodiode regions are arranged. For example, they may be selected immediately below the metal nano dots 5031, 5032, 5033 respectively.

In a microresonator 504 illustrated in FIG. 5D, a groove 5041 defining a scalene triangle is formed in an electro-conductive substrate 5042.

Any three positions that correspond to three sites where the magnitudes of the plasmon resonance generated in the microresonator 504 differ from each other may be selected as sites where photodiode regions are arranged. For example, they may be selected immediately below the sides of the scalene triangle defined by the groove 5041 respectively.

The groove 5041 may be formed simply as a space or filled with an insulator.

As pointed out above, any structure where a plurality of spatial frequently components are spatially unevenly distributed as a function of the wavelengths of light may be used for the purpose of the present invention. Each space frequency component may be distributed in single geometric structure. Or plural geometric structure corresponding to the space frequency component may be posted mutual neighborhood.

With any of the above-described structures, the optical intensities that correspond to R, G and B can be obtained by detecting the spatially polarized electric field intensity, using the method described above for Embodiment 1.

### Embodiment 3

Another embodiment of photodetection device according to the present invention will be described below. The microresonators of this embodiment are formed by dielectric micro cavities such as whispering gallery mode resonators.

A whispering gallery mode is a mode in which resonance takes place to move around in the inside of a micro-disk. Light that strikes the photodetection device then collides with the micro-disk resonator to give rise to resonance in a whispering gallery mode.

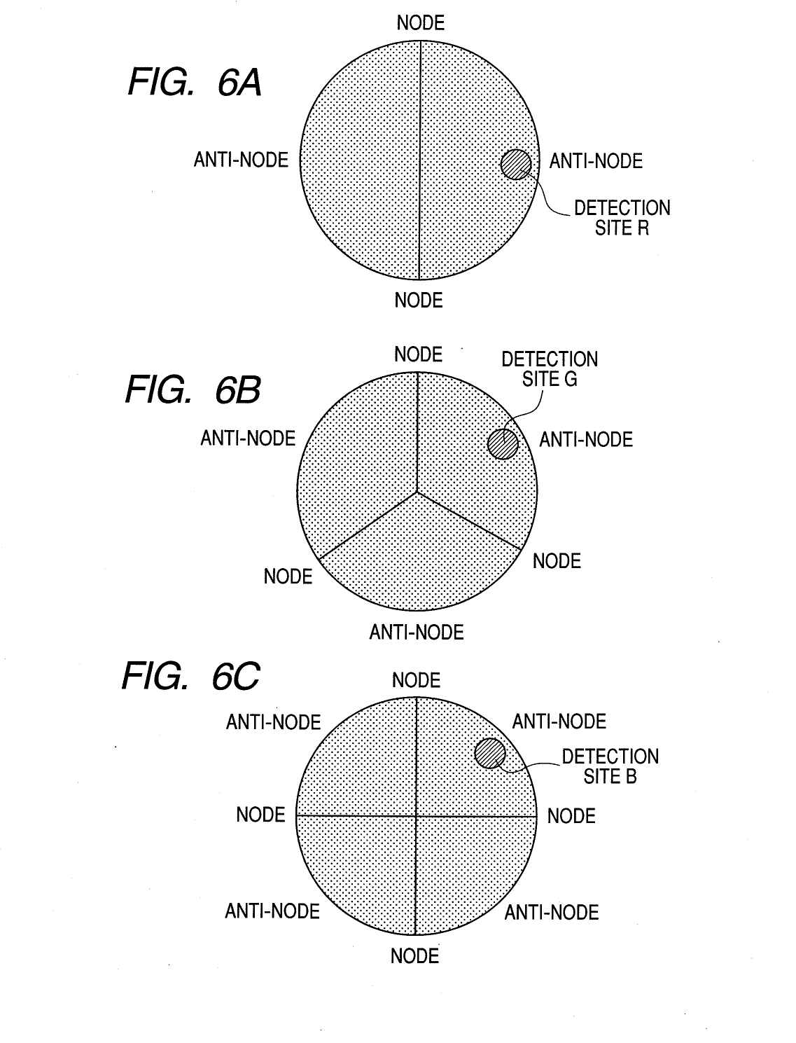

Assume here that SiO₂ (n=1.46) is selected as the material of the micro-disk having a diameter of 175 nm. FIGS. 6A through 6C illustrate the electric field amplitude distributions of light that correspond to 800 nm (R), 540 nm (G) and 400 nm (B) respectively.

As illustrated in FIGS. 6a through 6C, resonance takes place with anti-nodes (the positions that maximize the electric field amplitude) located at different parts of the microresonator.

The above-described three different resonance modes have respective anti-nodes and nodes that differ from node to node. A strong optical near field arises at an anti-node due to electric field enhancement. Therefore a signal can be obtained with a good S/N when light is received in the vicinity of such a site.

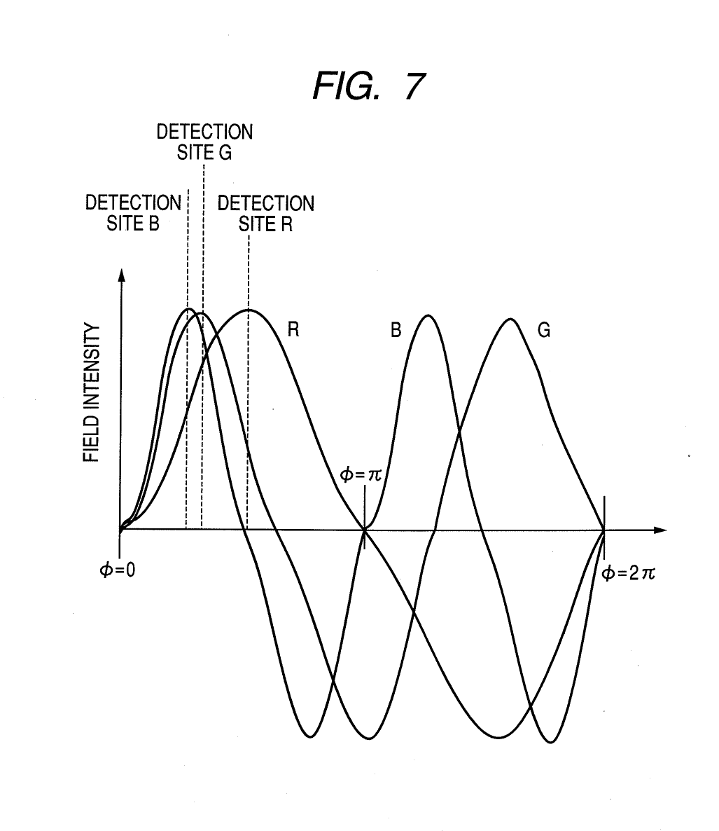

FIG. 7 is a graph illustrating the sites of anti-nodes and those of nodes of the electric field of wavelength as developed in a circumferential direction of a micro-disk resonator. The nodes can be fixed by inserting an anisotropic shape into part of the circumference.

The optical intensity of light of each of R, G and B can be found by means of the method described above for Embodiment 1 if the ratio by which the R, G and B components of light are distributed to A, B and C is known in advance by means of an electromagnetic field analysis or in an experiment.

When the refractive index of a whispering gallery mode resonator is large, the size of the resonator that corresponds to a certain wavelength can be made small. Then, resonators can be arranged highly densely. The plural resonance modes may be overlap spatially. Or, it may be posted mutual neighborhood.

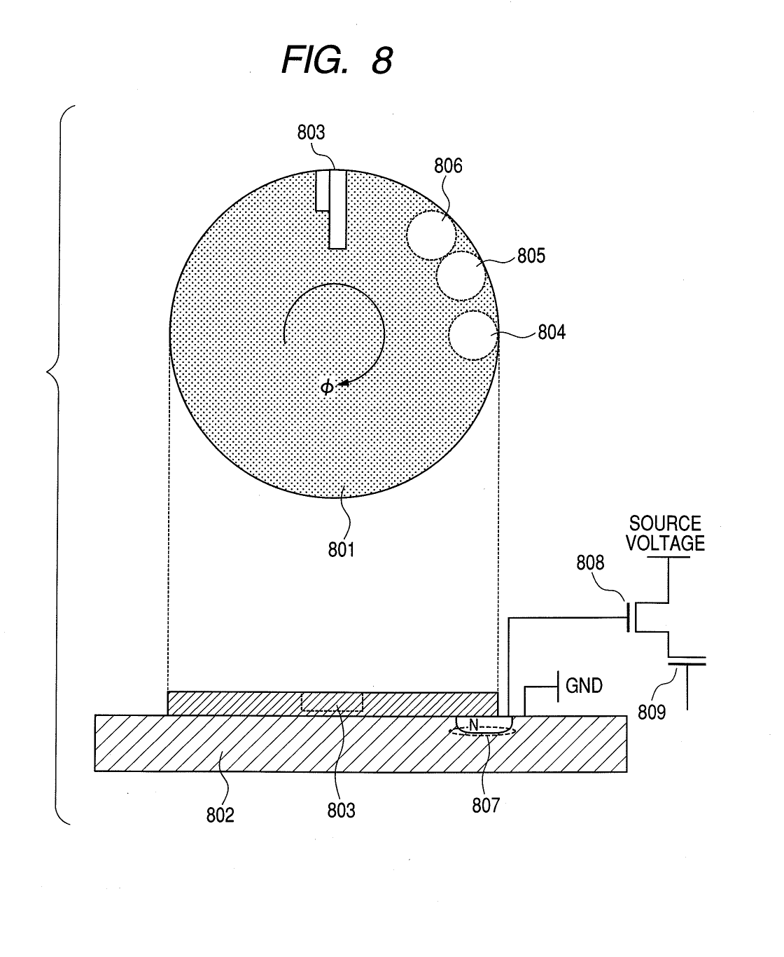

FIG. 8 schematically illustrates an example. Microresonator 801 is a dielectric whispering gallery mode resonator that is formed on a substrate 802. Light that strikes the resonator then gives rise to whispering gallery mode resonance as the positions of the nodes of the electric field are defined by a phase limiting structure 803.

Photodiode regions 807 are formed near the detection sites R804, G805 and B806 that are parts where the intensities of light of R, G and B can be detected with a good S/N.

The optical intensities that correspond to R, G and B can be obtained from the detected intensities of light by using the method described above for Embodiment 1.

The photodiode regions 807 output the respective intensities of the electric fields as so many quantities of electric charges. The electric charges are accumulated and subsequently amplified by an amplifier transistor 808 and output from a row selection transistor 809 with positional information.

A set of pieces of optical intensity information that correspond to the colors of R, G and B is obtained with positional information in the two-dimensional surface. Thus, a two-dimensional image can be formed by rearranging the pieces of information.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2007-077275, filed Mar. 23, 2007, which is hereby incorporated by reference herein in its entirety.

What is claimed is:

1. A photodetection device comprising:
a spectroscopic element formed by means of an optical microresonator having a plurality of resonant wavelength bands differentiated by positions as a function of geometric structure; and
a plurality of photoelectric conversion elements arranged at different positions to detect incident intensities of light of the plurality of resonant wavelength bands.

2. The device according to claim 1, wherein
an electromagnetic response is detected by the device.

3. The device according to claim 1, wherein
a thermal response is detected by the device.

4. The device according to claim 1, wherein
a chemical response is detected by the device.

5. The device according to claim 1, wherein
the optical microresonator is made of a metal.

6. The device according to claim 1, wherein
the optical microresonator is made of a semiconductor.

7. The device according to claim 1, wherein
the optical microresonator is made of a dielectric.

8. The device according to claim 1, wherein
the optical microresonator is made of a monocrystalline material.

9. The device according to claim 1, wherein
the optical microresonator is made of a polycrystalline material.

10. The device according to claim 1, wherein
the optical microresonator is made of an amorphous material.

11. The device according to claim 1, wherein
the optical microresonator is made of a plasmon resonator.

12. The device according to claim 1, wherein
the optical microresonator is made of a whispering gallery mode resonator.

13. The device according to claim 1, wherein
the photoelectric conversion elements are made of a photovoltaic material.

14. The device according to claim 1, wherein
the photoelectric conversion elements are made of a photoconductive material.

15. The device according to claim 1, wherein
the photoelectric conversion elements are made of a material that responds to light with energy higher than the wavelength band of incident propagating light.

16. A photodetection device comprising:
a spectroscopic element adapted to show a plurality of different resonant wavelength bands differentiated as a function of a geometric structure of an optical microresonator; and
a plurality of photoelectric conversion elements arranged at different positions to detect light of the plurality of resonant wavelength bands.

17. The photodetection device according to claim 16, wherein
the spectroscopic element has a shape of a triangle and three photoelectric conversion elements are arranged to correspond to three vertexes of the triangle.

18. An image sensor having a structure formed by two-dimensionally arranging optical microresonators according to any one of claims 1 through 16 on a planar surface or a curved surface.

19. A photodetection method comprising steps of:
making light to enter a spectroscopic element formed by means of an optical microresonator having different resonant wavelength bands differentiated by positions as a function of a geometric structure;
detecting a spatial polarization of photoelectromagnetic field distribution produced by resonance caused by the spectroscopic element as an optical intensity of each wavelength band by means of photoelectric conversion elements arranged at spatially different positions; and
outputting the detected optical intensity as signal.

20. The method according to claim 19, wherein
a nonadiabatic process is used the step for detecting the spatial polarization caused by resonance of light is a nonadiabatic process.

21. The method according to claim 19, further comprising steps of:
resynthesizing a color of incident light from the detection signal output; and
outputting the color as signal.

22. The method according to claim 21, wherein
the optical microresonators are two-dimensionally arranged on a planar surface or a curved surface and the method is adapted to detect a two-dimensional distribution of the optical intensity signal output based on the two-dimensional arrangement of the optical microresonators.
